(19) United States
(12) Patent Application Publication
(10) Pub. No.: US 2026/0256270 A1
(43) Pub. Date: Sep. 3, 2026

(54) MAGNETIC UTENSIL HOLDER

(71) Applicant: Andrew KLOOSTERMAN, Caldwell, ID (US)

(72) Inventor: Andrew KLOOSTERMAN, Caldwell, ID (US)

(21) Appl. No.: 19/554,551

(22) Filed: Mar. 2, 2026

Related U.S. Application Data
(60) Provisional application No. 63/765,932, filed on Mar. 3, 2025.

(51) Int. Cl. A45F 5/02; B43K 25/02

(52) U.S. Cl. CPC A45F 5/02; B43K 25/024

(57) ABSTRACT

A utensil holder attachable to personal clothing has an upper cap magnetically couplable to a complementary lower cap by a first magnet embedded within a bottom end of the upper cap and a second magnet embedded in an upper end of the lower cap. The upper cap includes a garment attachment mechanism. The lower cap is formed from an elastomer and has an open lower end and a hollow tapered interior that can frictionally releasably engage various types of utensils having elongated handles such as pens, pencils, carpenter pencils, lighters, and small hand tools.

### RELATED APPLICATIONS

This application claims priority to U.S. Provisional Application 63/765,932, filed Mar. 3, 2025, the contents of which are fully incorporated herein by reference.

### BACKGROUND OF THE INVENTION

### Field of the Invention

The disclosed invention relates generally to utensil holders, and, more specifically, to a magnetic utensil holder.

### Description of Related Art

Writing utensils, marking tools, and small handheld implements are indispensable across a broad spectrum of professional and recreational activities. In the skilled trades and hobbyist crafts, such as carpentry, masonry, and metalworking, precise marking of materials is a prerequisite for accurate cutting, drilling, and assembly. Similarly, in academic and professional office environments, physical writing utensils remain preferred for note-taking, complex problem-solving, and tactile drafting where digital interfaces are either impractical or less effective.

A perennial challenge for users of physical implements is the frequent misplacement or lack of immediate accessibility of the tool. In dynamic environments, such as construction sites or workshops, a user often transitions between tasks, leading to the utensil being set down and subsequently lost or forgotten.

Conventional methods for maintaining a tool on one's person are notoriously flawed. For example, storing a pencil behind the ear provides an insecure friction fit that is prone to failure during head movement, leading to the tool falling unnoticed. Alternatively, storage in a garment pocket often results in the tool’s sharpened tip puncturing the fabric or causing discomfort to the user when bending or sitting. Furthermore, the tip of the utensil is frequently subjected to shear forces in a pocket, leading to breakage and requiring frequent re-sharpening.

Prior attempts to solve these issues have introduced significant technical and ergonomic drawbacks. U.S. Patent No. 8,235,262, for instance, discloses a magnetic sleeve designed for a carpenter's pencil. However, this system relies on a specific magnetic coupling that requires a secondary, complementary magnet to be affixed to the user’s clothing. This necessitates a permanent or semi-permanent modification to various garments, which is cumbersome and limits the system's modularity. Moreover, the rigid geometry of such sleeves often restricts their use to specific utensil shapes (e.g., flat carpenter's pencils), rendering them incompatible with standard cylindrical pens or markers.

Retractable utensil holders, such as those disclosed in U.S. Patent No. 7,270,289, utilize a spring-loaded tether to prevent loss. While this keeps the tool attached to the body, the constant tension exerted by the retraction mechanism interferes with the user’s dexterity. In precision tasks, such as marking a fine line against a square, this "pull-back" force can introduce significant inaccuracies and user fatigue. Furthermore, the tether itself creates a snagging hazard in environments with moving machinery or tight spaces.

Therefore, there exists a need for a utensil retention system that provides secure, immediate access without requiring specialized clothing modifications, while ensuring that the tool remains free from restrictive tension during use and compatible with a variety of implement geometries.

### SUMMARY OF THE INVENTION

The present invention solves the abovementioned problems by providing a utensil holder that can be clipped anywhere on a person’s clothing and provides the operator with quick and easy access to the utensil or tool secured thereto. The present invention utilizes two caps that are magnetically coupled together, the upper cap being clippable to the person’s clothing and the lower cap being designed to receive the utensil. A variety of utensils or tools may be used with the present invention due to the tapered design of the lower cap material that allows frictional engagement with the utensil.

In one preferred embodiment, the utensil holder has an upper cap with a top end, a bottom end, and an upper body extending therebetween. A magnet is embedded in the upper body at the bottom end. The top end also includes a means for engaging a clip, the clip being usable to secure the upper cap to a person’s clothing. A lower cap has an upper end, an open lower end, and a hollow body extending therebetween. A complementary magnet is embedded in the upper end. The magnet and complementary magnet removably couple the upper cap to the lower cap. The hollow body of the lower cap is designed to removably engage a utensil or a tool, e.g., a carpenter’s pencil.

In some preferred embodiments, the interior of the hollow body tapers from the open lower end toward the upper end. The upper end is closed around the complementary magnet and defines a closed interior end of the hollow body. Preferably, the tapered interior of the hollow body is designed to frictionally engage an outer surface of variously sized utensils, e.g., a carpenter’s pencil, a lighter, or number 2 pencil.

In preferred embodiments, the upper cap is formed from an elastomer. The elastomer may be silicone. The lower cap may be similarly formed from an elastomer, such as silicone.

Preferably, the clip engagement means includes a horizontal aperture defined through the upper body proximate the top end. The aperture is configured to receive a wire from a clip.

In some embodiments, the upper end of the lower cap includes a perimetric lip extending upward therefrom. A planar surface, or flange surface, may extend inward from the lip and the complementary magnet may be secured under the planar surface and within the boundary of the perimetric lip. The bottom end of the upper cap may include an outer beveled edge and a planar extension. The magnet is preferably embedded within the planar extension. Preferably, the planar extension engages with the planar surface so that the outer beveled edge fits within the perimetric lip when the upper cap and lower cap are magnetically coupled together.

Additional optional features may be present in certain embodiments. For example, the upper cap may be bell-shaped. Or, the upper end of the lower cap may be closed to form a closed interior end of the hollow body. Or, the open lower end of the lower cap may be substantially circular. In some embodiments, the magnet and complementary magnet are neodymium rare-earth magnets with opposite polarity to provide for the magnetic coupling therebetween.

In an alternative embodiment, a badge clip may be attached to the utensil holder. The badge clip preferably has an upper cap with a top end, a bottom end, and an upper body extending therebetween. A magnet is embedded in the upper body at the bottom end and a means for engaging a clip is formed at the top end. A badge cap is configured to removably engage the upper cap. The badge cap has an upper end, a lower end, and a lower body extending therebetween. A complementary magnet is embedded in the upper end and configured to removably couple the badge cap to the upper cap. A means for engaging a strap is formed at the lower end of the badge cap.

In some preferred embodiments, the strap engagement means is formed by a first leg and a second leg extending from the lower end to form a channel or a gap. A stud, or screw post, preferably extends through the first and the second legs. The stud couples a strap, e.g., a button strap, to the badge cap within the channel. The badge clip may also include a button strap attached to the lower end via the strap engagement means.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is an exploded side view of one embodiment of a utensil holder according to the present invention.

FIG. 2 is an exploded cross-sectional side view, taken along lines A-A of FIG. 1, of an embodiment of the utensil holder.

FIG. 3 is a partially transparent side view of one embodiment according to the invention of a utensil holder shown engaged to a utensil.

FIG. 4 is a perspective view of an embodiment of an upper cap for a utensil holder according to the present invention.

FIG. 5 is a perspective view of an embodiment of a lower cap for a utensil holder according to the present invention.

FIG. 6 is a perspective view of an alternative embodiment of a lower cap, or badge cap, for utensil holder according to the present invention.

FIG. 7 is a side view of an embodiment of a badge cap for a utensil holder according to the present invention.

### DETAILED DESCRIPTION OF THE INVENTION

The following disclosure presents exemplary embodiments of a magnetic utensil holder that can be removably attached to a person at virtually any location on any type of clothing. The utensil holder according to the present invention provides a person with quick and convenient access to their attached utensil, without any large or cumbersome housing interfering with the normal use of the utensil. Further, the magnetic connection utilized allows a person to store the utensil after use without the benefit of visual guidance by simply placing the magnetic ends near one another to allow magnetic force to join the holder to its cap.

In specific embodiments discussed herein, the magnetic utensil holder according to the present invention is shown and described as fitting a standard carpenter’s pencil and a standard number 2 pencil. The invention, however, is not so limited. The embodiments shown and described can also be used to store other writing utensils and small tools that are not illustrated in the drawings. A non-exhaustive list of potential utensils that may be used with the present invention includes pens, markers, screwdrivers, small flashlights, lighters, lip balms, lipsticks, among other types of small hand tools, utensils and other similar personal items having an elongated end or handle.

FIG. 1 is an exploded side view of a magnetic utensil holder according to the present invention. The magnetic utensil holder 10, hereinafter utensil holder 10, includes an upper cap 12 and a lower cap 14. The upper cap 12 and lower cap 14 are magnetically coupled to one another, as described further below, to form the utensil holder 10.

The upper cap 12 has an upper body 16 with a top end 18 and a bottom end 20. The top end 18 has a means for engaging a clip, the means formed in the top end 18. In preferred embodiments, the clip engagement means 22 is an aperture 22 defined through the upper body 16 proximate the top end 18. A garment attachment mechanism, such as a clip, 24 may be engaged to the aperture 22 by positioning a wire loop 26 therethrough. Note, while a clip 24 with a wire loop 26 is shown, the garment attachment mechanism includes other types of clips, such as a split keyring and a carabiner clip. The clip 24 allows upper cap 12 to be attached at virtually any position on a user’s clothing, e.g., any place on a shirt, pockets, belt, hat, etc. A first magnet 28 is embedded within the bottom end 20 of the upper body 16.

The lower cap 14 has an upper end 30 and an open lower end 32. A flexible hollow body 34 extends between the upper end 30 and the open lower end 32. As will be described further below, the open lower end 32 is designed to receive a utensil so that the hollow body 34 fits over the utensil and is held partially within the hollow body 34 due to friction. The hollow body 34 is frictionally releasably engageable to various types of utensils. A second magnet 36, complementary to the first magnet 28, is embedded in the upper end 30 of the lower cap 14.

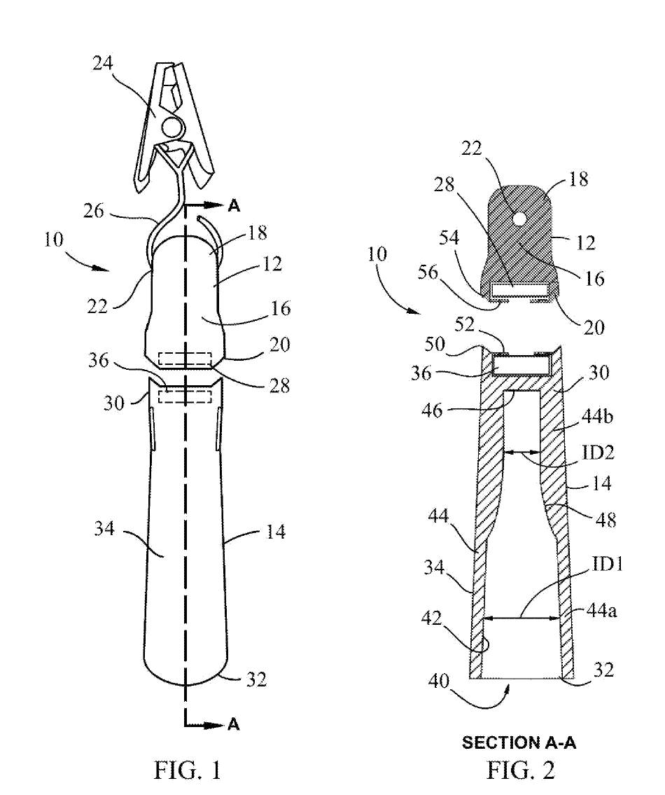

FIG. 2 is a cross-sectional side view, taken along lines A-A, of the magnetic utensil holder according to the present invention. Note, in this view the clip 24 and wire loop 26 have been removed from the upper cap 12. The open lower end 32 has an opening 40 that opens into a hollow interior 42 of the flexible body 34. The sidewall 44 forming the flexible body 34 preferably tapers from the open lower end 32 toward the upper end 30. In some embodiments, the sidewall 44 has a lower section 44a defining a first internal diameter ID1 of the hollow interior 42 and an upper section 44b defining a second internal diameter ID2 of the hollow interior 42. A tapered section 48 connects the lower section 44a to the upper section 44b, transitioning the ID1 into the ID2. The different sections of the hollow interior 42, i.e., the lower section 44a, the tapered section 48 and the upper section 44b, are designed so the flexible body 34 can engage tools and utensils having various shapes and outer diameters. For example, the ID1 of the lower section 44a may fit a standard carpenter’s pencil having a width of about 0.5 inches while the ID2 of the upper section 44b may fit a standard number 2 pencil having a diameter of about 0.27 inches. The flexibility of the flexible body 34 allows the sidewall 44 to stretch to fit over the engaged utensil 38 and conform to the outer surface of the utensil engaged therein.

In preferred embodiments, the upper cap 12 and the lower cap 14 are each made from a flexible elastomer, such as molded silicone. Other types of elastomer materials may also be used, including natural and synthetic rubber, thermoplastic polyurethane, or nitrile. These materials, particularly silicone, provide the necessary flexibility for the opening 40 at the lower end 32 to receive various sized utensils while maintaining sufficient friction between the interior surface of the sidewall 44 and the engaged utensil to secure the utensil within the hollow interior 42 of the body 34 and prevent it from disengaging by force of gravity. The elastomer of lower cap 14 and sidewall 44, however, do not introduce so much friction that would prevent a user from easily freeing the utensil by manually pulling it away from the lower cap. The flexibility of the body 34 also allows the sidewall 44 to conform to the engaged utensil so that the utensil holder 10 is not limited to rounded objects, e.g., the invention can secure a lighter, a carpenter’s pencil and a standard hexagonal pencil with the same efficacy.

The upper end 30 is closed and forms an interior surface 46 of the hollow interior 42. The second magnet 36 is embedded within the body 34 between the upper end 30 and the interior surface 46. The upper end 30 also includes a perimetric lip 50 extending upward therefrom and a planar surface, or flange surface, 52 extending inward from the lip 50. The second magnet 36 is secured in the upper end 30 below the planar surface 52 and within the boundaries of the lip 50. The bottom end 20 of the upper cap 12 has a beveled edge 54 formed thereabout and a planar extension 56 securing the first magnet 28 in the upper cap 12. In preferred embodiments, the upper cap 12 and lower cap 14 are geometrically complementary so that the planar extension 56 sits securely on the planar surface 52. The beveled edge 54 mates with the perimetric lip 50 to provide a substantially smooth transition from the upper cap 12 to the lower cap 14 while ensuring proper engagement between the first magnet 28 and second magnet 36. The magnetic connection between the first magnet 28 and the second magnet 36 removably couples the upper cap 12 and the lower cap 14 together to form the magnetic utensil holder 10.

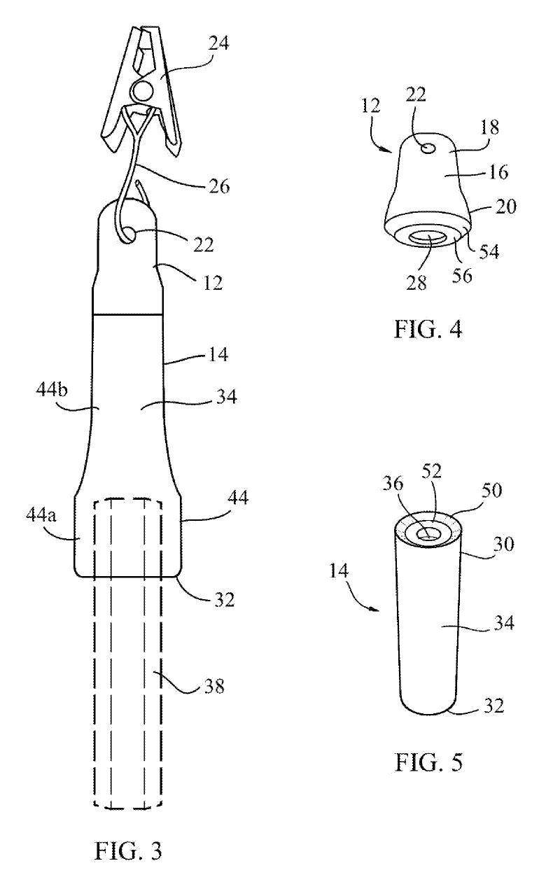

FIG. 3 is a partially transparent side view of an embodiment of the utensil holder engaged with a utensil. The utensil 38 engaged by the utensil holder 10 in this view may be a carpenter’s pencil, having a width of about 0.5 inches. Note, the utensil 38 is generically illustrated and the sidewall 44 is partially transparent to demonstrate the utensil 38 fitting within the hollow interior 42. The sidewall 44 of the flexible body 34 conforms to the shape of the utensil 38 to secure the utensil within the hollow interior 42 of the body 34. More specifically, the lower section 44a engages the carpenter’s pencil 38 while the upper section 44b remains unengaged. Due to the shape of the carpenter’s pencil 38, the utensil is not able to extend past the tapered section 48 of the sidewall 44. However, as discussed above, the flexibility of the material forming the body 34 and the friction between the inner surface of the sidewall 44 and the utensil 38 provided thereby is sufficient to maintain securement of the utensil 38 within the hollow interior 42 of the lower cap.

An operator may hang the utensil holder 10 from their shirt during use by engaging the clip 24 thereon. The operator has access to the utensil 38 and may freely use such by simply pulling the utensil 38 and the lower cap 14 from the upper cap 12 to obtain unobstructed use of the utensil 38. The upper cap 12 remains engaged to their shirt via the clip 24. The utensil 38 similarly remains engaged to the lower cap 14 due to friction. After use, the operator may restore the utensil holder 10 by positioning the lower cap 14 in proximity of the upper cap 12 to allow the magnets 28 and 36 to reengage.

FIG. 4 is a perspective view of an embodiment of the upper cap and FIG. 5 is a perspective view of an embodiment of the lower cap. As briefly mentioned above, preferred embodiments of the utensil holder 10 include the upper cap 12 and the lower cap 14 being made from molded silicone. More specifically, it is preferred that the upper cap 12 and lower cap 14 are injection molded using silicone materials, according to known injection molding techniques. Preferably, the first magnet 28 is overmolded with the silicone material to form the upper cap 12. The first magnet 28 may therefore be described as being embedded within the upper cap 12. Similarly, the second complementary magnet 36 is preferably overmolded with the silicone material to form the lower cap 14, also resulting in the second magnet 36 being embedded therein. This molding technique ensures that the magnets 28, 36 are fully secured within their respective caps 12, 14 so the utensil holder 10 is sufficiently durable to withstand use on a job site or other similar environments that may subject the utensil holder 10 to rough handling.

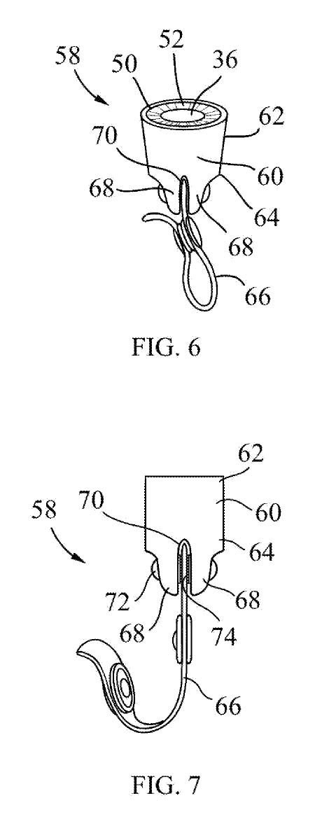

FIG. 6 is a perspective view of an alternative embodiment of a lower cap. FIG. 7 is a side view of the alternative embodiment of a lower cap. The alternative lower cap 58 is referred to as a badge cap 58 and is specifically designed to provide the same detachability of the lower cap 14 but integrated with a means 66 for removably engaging a badge or identification card. More specifically, the badge cap 58 includes a body 60 having an upper end 62 and a lower end 64. The upper end 62 is designed substantially similar to the upper end 30 the lower cap 14 described above. The upper end 62 thus includes a perimetric lip 50 extending upward therefrom and a planar surface 52 extending inward from the lip 50. The second magnet 36 is also similarly embedded within the upper end 62, secured under the planar surface 52 extending from the lip 50.

Extending from the lower end 64 is the badge removable engagement means 66. Preferably, the means 66 includes a button strap 66 fixedly attached to the lower end 64. In preferred embodiments, the lower end 64 has two legs 68 extending therefrom. The legs 68 are separated to form a channel or a gap 70 and a screw post 72 extends therethrough. The first end 74 of the button strap 66 is positioned in the gap 70 between the legs 68. The screw post 72 extends through the legs 68 to secure the first end 74 of the button strap 66 to the lower end 64 of the badge cap 58. The button strap 66 is able to rotate around the screw post 72.

The badge cap 58 embodiment may be used with any type of badge or ID card that can be connected to the button strap. For example, a nurse or other type of service worker may use the badge cap 58 as a device for displaying their ID card. The badge cap 58 allows a worker to securely display their ID card on the outside of their scrubs, as described above, by engaging the clip 24 thereto. The badge cap 58 couples to the upper cap 12 in the same manner as the lower cap 14 does. A worker may easily decouple the badge cap 58 from the upper cap 12 by simply pulling the badge cap 58 off the upper cap 12. This provides a convenience for workers who are required to frequently swipe an ID card between access points or are otherwise constantly having to provide identification. After use of their ID card, the badge cap 58 can be easily returned and reengaged to the upper cap 12 through the magnetic interaction of the embedded magnets 28, 36. Note, other types of straps 66 may be used to secure the badge or ID card to the badge cap 58. Button strap 66 is shown only as one example of many connection devices.

In some embodiments of the badge cap 58, a more rigid polymer may be preferred over silicone. For example, acrylonitrile butadiene styrene (“ABS”), polyoxymethylene (“POM”) or acetal polymers may be used to injection mold the badge cap 58.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A utensil holder, comprising:
an upper cap having a top end, a bottom end, an upper body extending between the top end and the bottom end, and a magnet embedded in the upper body at the bottom end, the top end having a means for engaging a clip; and
a lower cap having an upper end, an open lower end, a hollow body extending between the upper end and the open lower, and a complementary magnet embedded in the upper end and configured to removably couple the upper cap to the lower cap, wherein the hollow body is configured to removably engage a utensil.

2. The utensil holder of claim 1, wherein an interior of the hollow body tapers from the open lower end toward the upper end.

3. The utensil holder of claim 2, wherein the upper end is closed around the magnet and defines a closed interior end of the tapered hollow body.

4. The utensil holder of claim 2, wherein the tapered hollow body is configured frictionally engage an outer surface of variously sized utensils.

5. The utensil holder of claim 4, wherein the taper of the hollow body is configured to frictionally engage a carpenter’s pencil.

6. The utensil holder of claim 4, wherein the taper of the hollow body is configured to frictionally engage a number 2 pencil.

7. The utensil holder of claim 1, wherein the lower cap is an elastomer.

8. The utensil holder of claim 1, wherein the clip engagement means comprises a horizontal aperture defined through upper body proximate the top end and configured to receive a wire from the clip.

9. The utensil holder of claim 1, wherein the upper end of the lower cap comprises a perimetric lip extending upward.

10. The utensil holder of claim 9, wherein the complementary magnet is embedded in a planar surface within a boundary of the perimetric lip.

11. The utensil holder of claim 10, wherein bottom end of the upper cap comprises a planar extension and a beveled outer edge extending from the planar extension into the upper body.

12. The utensil holder of claim 11, wherein the magnet is embedded within the planar extension.

13. The utensil holder of claim 12, wherein the planar extension is configured to engage the planar surface within the perimetric lip.

14. The utensil holder of claim 1, wherein the upper cap is bell-shaped.

15. The utensil holder of claim 1, wherein the upper end of the lower cap is closed to define a closed interior end of the hollow body.

16. The utensil holder of claim 1, wherein the open lower end is substantially circular.

17. The utensil holder of claim 1, wherein the magnet and the complementary magnet comprise neodymium rare-earth magnets.

18. A badge clip, comprising:
an upper cap having a top end, a bottom end, an upper body extending between the top end and the bottom end, and a magnet embedded in the upper body at the bottom end, the top end having a means for engaging a clip;
a badge cap having an upper end, a lower end, a lower body extending between the upper end and the lower, and a complementary magnet embedded in the upper end and configured to removably couple the upper cap to the lower cap; and
a strap engagement means formed at the lower end of the lower cap.

19. The badge clip of claim 18, wherein the strap engagement means comprises a first leg extending from the lower end, a second leg extending from the lower end, a channel formed between the first leg and the second leg, and a stud extending between the first leg and the second leg to couple a strap to the lower cap.

20. The badge clip of claim 19, further comprising a button strap attached to the lower end via the strap engagement means.
